(19) United States
(12) Patent Application Publication
(10) Pub. No.: US 2019/0232216 A1
(43) Pub. Date: Aug. 1, 2019

(54) Carbon Dioxide Capture And Conversion Methods And Systems

(71) Applicant: The University Court Of The University Of Aberdeen, Aberdeen, Aberdeenshire (GB)

(72) Inventors: Mohammed Salah-Eldin Imbabi, Aberdeen, Aberdeenshire (GB); Fredrick Glasser, Aberdeen, Aberdeenshire (GB)

(21) Appl. No.: 16/312,082

(22) PCT Filed: Jul. 12, 2017
(86) PCT No.: PCT/GB2017/052035

§ 371 Date: Dec. 20, 2018

(30) Foreign Application Priority Data
Jul. 12, 2016 (GB) 1612102.2

(51) Int. Cl. B01D 53/14; C01F 11/18; C01F 5/24; B01D 53/78; F25J 3/02

(52) U.S. Cl. CPC B01D 53/1475; B01D 53/1493; C01F 11/181; C01F 5/24; B01D 53/78; B01D 2258/0283; B01D 2258/025; B01D 2257/504; B01D 2252/102; B01D 2258/0233; F25J 3/0266

(57) ABSTRACT

The present invention provides a method of mineralisation of carbon dioxide. The method comprises forming an alkaline in aqueous solution containing carbonate anions by dissolving the carbon dioxide and an alkali such as ammonia in water. Next, the method comprises mixing the alkaline aqueous solution with a water source (such as a connate/formation brine or produced water or industrial waste waters or re-constituted mineral-bearing waters) containing magnesium and calcium cations. A first product (e.g. PCC) containing calcium cations and carbonate anions is precipitated in a first precipitation step at a first pH (e.g. around pH7.5) and then a second product (e.g. nesquehonite (NQ) a type of PMC) containing magnesium cations and carbonate anions is precipitated in a second precipitation step at a second, higher pH e.g. around pH 9.5.

### FIELD OF THE INVENTION

The present invention relates to methods and systems for the capture and conversion of carbon dioxide, in particular to methods and systems for mineralisation of carbon dioxide to produce practically and commercially useful, non-hazardous solid materials.

### BACKGROUND OF THE INVENTION

Global warming/climate change arising from the increase of greenhouse gases in the atmosphere is well documented and presents a highly undesirable threat to numerous ecosystems at both local and planetary scales. Greenhouse gases such as carbon dioxide are predominantly released into the atmosphere during combustion of carbon-based fuels such as coal, oil and natural gas e.g. in power plants, as well as during industrial processes such as calcination used in cement production.

Although carbon dioxide is naturally captured from the atmosphere through biological processes such as photosynthesis by land and marine plant-life, the concentration of carbon dioxide in the atmosphere continues to rise. Carbon dioxide is also responsible for the acidification of the World's oceans posing a threat to marine ecosystems.

Artificial processes for carbon capture/sequestration for reducing the amount of atmospheric carbon dioxide have been proposed.

The reaction of gaseous carbon dioxide to produce metal salts is known. Dissolution of carbon dioxide in aqueous, alkaline solutions yields carbonate (CO₃²⁻) and bicarbonate (HCO₃⁻) ions. Reaction of these anions with metal cations yields solid metal carbonates. Production of magnesium carbonate-containing products is known using desalination water i.e. brine produced as a waste product during the desalination process, as the source of magnesium cations. Certain magnesium carbonate-containing products, e.g. nesquehonite (NQ), were found (by the inventors) to be of potential interest to the construction industry.

There is a need for an improved mineralisation process to increase the amount of carbon that can be captured and the range of useful solid products that can be obtained, by increasing the sources of metal cations that can be used in the process.

Precipitated calcium carbonates are commercially valuable materials whose traditional production involves calcination of limestone. Unfortunately, calcination requires considerable energy and releases significant amounts of carbon dioxide into the atmosphere. There is thus a need for a more environmentally friendly method for making precipitated calcium carbonate.

### SUMMARY OF THE INVENTION

In a first aspect, the present invention provides a method of mineralisation of carbon dioxide, the method comprising:
forming an alkaline aqueous solution containing carbonate anions by dissolving the carbon dioxide and an alkali in water;
mixing the alkaline aqueous solution with a water source containing magnesium and calcium cations;
selectively precipitating a first product containing calcium cations and carbonate anions in a first precipitation step at a first pH; and
then selectively precipitating a second product containing magnesium cations and carbonate anions in a second precipitation step at a second pH, wherein the second pH is higher than the first pH.

By using a water source containing magnesium and calcium ions and carrying out at least two sequential precipitation steps at different pH values (both of which will be higher than the pH of the water source), it is possible to selectively precipitate at least two useful solid products: a first product having calcium as the main cation along with carbonate anions; and a second product having magnesium as the main cation along with carbonate anions.

The first (calcium) products have proven uses in the paper-making, polymer, paints, adhesives, healthcare, food, agriculture and construction industries. Their production using the new method does not release any significant amounts of carbon dioxide, but instead enables carbon dioxide to be captured e.g. from combustion wastes and converted to useful products at low cost. The second (magnesium) products can be processed (as disclosed by the inventors) to produce cementious construction materials that can form dimensionally stable building products such as wallboards, insulation panels, and lightweight construction blocks.

Optional features of the invention will now be set out. These are applicable singly or in any combination with any aspect of the invention.

In some embodiments, the water source is a brine such as desalination brine, formation/connate brines, produced water brines (obtained as a by-product of gas/oil extraction), or other natural or industrial process waste brine (such as tailings ponds from oil sands extraction). The water source has a pH which is lower than the first and second pH.

In some embodiments, the carbon dioxide is derived from a waste gas such as an effluent gas from an industrial plant e.g. a power plant, a chemical processing plant, a cement factory, an oil refinery or some other man-made source. A waste gas from a coal combustor typically comprises nitrogen (around 74%), oxygen (around 3%), water vapour (around 8%) and carbon dioxide (around 15.5%). Cement kilns give rise to effluent gases with an even higher carbon dioxide content (around 28%). In other embodiments, the carbon dioxide may be derived from a waste gas generated during activation by heating of the second product or derived from forming the second product into construction materials.

The waste gas is preferably passed through a carbon dioxide scrubber to separate the carbon dioxide from other components of the waste gas. Any oxygen and nitrogen in the waste gas are typically vented to atmosphere. Optionally, the waste gas may be passed through a particulate matter (PM) filter to remove particulates and/or a thermal heat exchanger to recover waste heat for use in other steps of the capture and conversion processes, for example drying. The waste gas may be passed through a water recovery unit for recovering water from the waste gas. The recovered water may be used in the washing step(s) described below. Recovering water from the waste gas helps reduce dilution of the calcium and magnesium cations in the water source and also reduces the demand for fresh water in the washing step(s).

The alkali for forming the alkaline aqueous solution may be sodium hydroxide. The molar ratio of the alkali to the carbon dioxide in this case is preferably between 1and 2. Other alkalis, for example, potassium hydroxide or calcium hydroxide could be used, but not necessarily at the same molar ratio e.g. a molar ratio of alkali to carbon dioxide of 1.2 to 1.5 could be used.

The alkali may comprise Clinker Kiln Dust (CKD), which is a waste material produced in the manufacture of Portland cement that is often disposed of as a low hazard material in landfill. Its composition is variable but typically comprises alkali-metal sulphates and oxides such as sodium hydroxide and potassium hydroxide which can be dissolved to yield hydroxide anions (OH⁻). An alkaline aqueous solution formed by the addition of CKD may be filtered to remove any suspended particulates. CKD may be used in combination with sodium hydroxide or another alkali.

The alkali may comprise fly ash, also known as Pulverised Fuel Ash (PFA), which is a coal combustion product, the bulk of which is invariably disposed in landfill. Its composition is variable but typically contains both amorphous and crystalline silicon dioxide, aluminium oxide and calcium oxide, which can be dissolved to yield hydroxide anions (OH⁻). An alkaline aqueous solution formed by the addition of PFA may be filtered to remove any suspended particulates. PFA may be used in combination with sodium hydroxide or another alkali such as CKD.

The alkali may comprise Lime Sludge (LS), which is a waste material from wastewater remediation and purification. It is a semi-solid slurry produced as sewage sludge from the application of lime (CaO) as a biocide in wastewater treatment processes or as a settled suspension obtained from conventional drinking water treatment and numerous other industrial processes. If the correct quicklime, hydrated lime or liquid lime dose is applied, the treated sludge will be elevated to pH 12 for at least 72 hours. LS will increase Ca ion availability and can be used in combination with sodium hydroxide and CKD or another alkali

The alkali may comprise ammonia. Ammonia dissociates into ammonium ions (NH₄⁺) and hydroxide anions upon dissolution in water. The molar ratio of the ammonia to the carbon dioxide in this case is preferably around 1. Ammonia is a preferred alkali since it can be recycled (or regenerated) and re-used as discussed below. In contrast, sodium hydroxide is traditionally non-recoverable, irrespective of how it is made, whether using the traditional, high cost, high carbon intensity chlor-alkali process or lower cost, less energy intensive or renewable energy processes. The use of sodium hydroxide comes at high energy cost and involves the release of significant amounts of carbon dioxide.

In preferred embodiments, the alkali is added to water to form a controlled pH alkaline aqueous solution (e.g. having a pH of around 9.5) prior to dissolution of the carbon dioxide to form the alkaline aqueous solution containing carbonate ions. The carbon dioxide may be bubbled through or sprayed onto the alkaline aqueous solution. Alternatively, the carbon dioxide may react with the alkaline aqueous solution in a packed, contra-flow absorption column. In other embodiments, the alkaline aqueous solution may be sprayed into/across the flow path of a carbon dioxide-rich gas stream.

The carbon dioxide (e.g. from the waste gas) reacts with the hydroxide anions in the alkaline aqueous solution to form the carbonate ions as follows:

CO₂(g)+2OH⁻(aq)CO₃²⁻(aq)+H₂O(I) (1)

Bicarbonate ions may also be formed as follows:

CO₂(g)+CO₃²⁻(aq)+H₂O(I)→2HCO₃⁻(aq) (2)

Where the alkali is or includes sodium hydroxide, the following reactions occur to generate the alkaline aqueous solution containing carbonate (and bicarbonate) ions:

CO₂(g)+2NaOH(aq)→Na₂CO₃(aq)+H₂O(I) (3)

CO₂(g)+Na₂CO₃(aq)+H₂O(I)→2NaHCO₃(aq) (4)

In these embodiments, the carbon dioxide is dissolved in the alkaline aqueous solution at a temperature of between 0-30° C.

Where the alkali is ammonia, the following reactions occur to generate the alkaline aqueous solution containing carbonate (and bicarbonate) ions:

CO₂(g)+2NH₃(aq)+H2O(I)→(NH₄)₂CO₃(aq) (5)

CO₂(g)+NH₃(aq)+H₂O(I)→(NH₄)HCO₃(aq) (6)

CO₂(g)+(NH₄)₂CO₃+H₂O(I)→2NH₄HCO₃(aq) (7)

In these embodiments, the carbon dioxide is dissolved in the alkaline aqueous solution at a temperature of between 0-30° C. The process of dissolving carbon dioxide in an ammonia solution is described in patent no. GB2454266B to Alstom.

The water source (e.g. brine) contains both calcium and magnesium ions. They may be present as calcium chloride and magnesium chloride. Where the water source is a brine, it will also contain sodium chloride. Brines that are as high as 1M with respect to sodium chloride have found to be useful in the present invention without having a detrimental effect on the precipitation of the products.

The Ca²⁺ ion:Mg²⁺ ion ratio may be 1:10 to 10:1. The water source/brine may contain a higher concentration of calcium ions than magnesium ions. The ratio of calcium ions to magnesium ions in the water source can be as high as 6:1 or 7:1, or in some cases even higher e.g. 10:1 or 11:1.

The water source/brine preferably contains calcium ions (e.g. as calcium chloride) in a concentration range of between 2.5 to 100 g/L and magnesium ions (e.g. as magnesium chloride) in a concentration range of 2.5 to saturation e.g. 2.5 to 50 g/L e.g. around 9 g/L.

The water source/brine may be filtered and/or treated prior to mixing with the alkaline aqueous solution containing carbonate ions. For example, as is the case for produced water brines, the process may further comprise one or more of a de-oiling step (e.g. using a de-oiling cyclone), a soluble organics removal step, a solids removal step (e.g. using a wellhead de-sanding cyclone) and/or a dissolved gas removal step (e.g. using a dissolved air flotation unit). The dissolved gases removed by the dissolved gas removal step may be supplied to the carbon dioxide scrubber to extract carbon dioxide for dissolution to form the alkaline aqueous solution. Such filtering/treatment steps are already in use and would normally form part of the oil or gas production facility, to ensure compliance with existing industry standards, which prevent the release of untreated oil well brines to the environment.

The alkaline aqueous solution containing the carbonate ions is preferably mixed with the water source/brine at a temperature of between 0-30° C. (e.g. around 5° C.) and ambient pressure.

The first precipitation step (for precipitating the first (calcium) product) may be carried out at a first pH of ≤8.5, preferably between pH 7-8. The first precipitation step may be carried out at ambient pressure.

The first precipitation step may be carried out at a temperature between 0-85° C. e.g. between 0-60° C.

The first precipitation step may comprise any of the following reactions:

CO₃²⁻(aq)+Ca²⁺(aq)→CaCO₃(s) (8)

CO₃²⁻(aq)+Ca²⁺(aq)+xH₂O(I)→CaCO₃.xH₂O(s) (9)

Where the alkali is sodium hydroxide and the calcium ions are initially present as calcium chloride, the first precipitation step may comprise the following reactions:

Na₂CO₃(aq)+CaCl₂(aq)→CaCO₃(s)+2NaCl(aq) (10)

Na₂CO₃(aq)+CaCl₂(aq)+xH₂O(I)→CaCO₃.xH₂O(s)+2NaCl(aq) (11)

Where the alkali is ammonia and the calcium ions are initially present as calcium chloride, the first precipitation step may comprise the following reactions:

(NH₄)₂CO₃(aq)+CaCl₂(aq)→CaCO₃(s)+2NH₄Cl(aq) (12)

(NH₄)₂CO₃(aq)+CaCl₂(aq)+xH₂O(I)→CaCO₃.xH₂O(s)+2NH₄Cl aq) (13)

The person skilled in the art will appreciate that the chloride anion may be replaced by an alternative anion for the reactions shown in the first precipitation step.

The first (calcium) product may comprise precipitated calcium carbonate (PCC), which can be used in the paper-making, polymer, healthcare, food, agriculture and construction industries.

The PCC may have the β-CaCO₃ structure known as calcite or it may have the λ-CaCO₃ form known as aragonite. Calcite/aragonite production is favoured at a pH of ≤7.5, preferably between pH 7-7.5 e.g. around pH 7.5. The mineral form obtained depends on the temperature of the first precipitation step.

A temperature of ≥40° C. e.g. 40-85° C. (e.g. 40-60° C.) for the first precipitation step favours aragonite. Formation of aragonite may be preferable since it is unlikely that magnesium cations will form a solid solution with aragonite leaving more magnesium cations in solution available for precipitation in the second precipitation step. Aragonite may be useful as a weighting agent and/or opacifier in paint and filter applications.

Calcite formation may be favoured through using a temperature of 0-30° C. for the first precipitation step.

The PCC may comprise calcium carbonate monohydrate, also known as monohydrocalcite (mhc) which can be precipitated at a temperature of 0-30° C. Monohydrocalcite production is favoured at a pH of 8≤pH>7.5.

The first (calcium) product is separated (e.g. filtered) from the first supernatant liquid (which will still contain magnesium cations and carbonate/bicarbonate anions) and is preferably washed (to remove chloride salts and residual alkali) and dried e.g. dried under vacuum or spray dried, etc.

The first supernatant liquid is then subjected to the second precipitation step (for precipitating the second (magnesium) product) which may be carried out at a second pH of >8.5, such as pH≥9, more preferably pH≥9.5 most preferably between pH 9.5 to 10 e.g. around pH 10. The increase in pH after the first precipitation step may be achieved by the addition of alkali e.g. one or more of the alkalis discussed above to the first supernatant liquid.

The second precipitation step may comprise any of the following reactions:

CO₃²⁻(aq)+Mg²⁺(aq)→MgCO₃(s) (14)

CO₃²⁻(aq)+Mg²⁺(aq)+xH₂O(I)→MgCO₃.xH₂O(s) (15)

Where the alkali is sodium hydroxide and the magnesium ions are present as magnesium chloride, the second precipitation step may comprise the following reactions:

Na₂CO₃(aq)+MgCl₂(aq)→MgCO₃(s)+2NaCl(aq) (16)

Na₂CO₃(aq)+MgCl₂(aq)+xH₂O(I)→MgCO₃.xH₂O(s)+2NaCl(aq) (17)

Where the alkali is ammonia and the calcium ions are present as calcium chloride, the second precipitation step may comprise the following reactions:

(NH₄)₂CO₃(aq)+MgCl₂(aq)MgCO₃(s)+2NH₄Cl(aq) (18)

(NH₄)₂CO₃(aq)+MgCl₂(aq)+xH₂O(I)→MgCO₃.xH₂O(s)+2NH₄Cl aq) (19)

The person skilled in the art will appreciate that the chloride anion may be replaced by an alternative anion in the reactions shown for the second precipitation step.

The second (magnesium) product may be a precipitated magnesium carbonate (PMC) including magnesium carbonate and/or its hydrates (e.g. nesquehonite (MgCO₃.3H₂O)) and/or magnesium hydroxy carbonate and/or its hydrates (e.g. hydromagnesite (Mg₅(CO₃)₄(OH)₂.4H₂O). The second (magnesium) product preferably comprises nesquehonite (NQ).

Production of PMC can be favoured by using a temperature of less than or equal to 40° C. preferably less than or equal to 25° C. for the second precipitation step. Agitation (e.g. stirring) is also desirable for the precipitation of PMC.

The second (magnesium) product may be de-watered to produce a slurry or separated (e.g. filtered) from the second supernatant liquid and is preferably washed (to remove chloride salts and residual alkali) and dried e.g. dried under vacuum or spray dried etc. Water recovered during the drying step(s) may be recycled for use in the washing step(s).

In some embodiments, the method further comprises at least one intermediate precipitation step for precipitating at least one intermediate product comprising calcium and/or magnesium cations and carbonate anions. In some embodiments, the intermediate product is monohydrocalcite. The intermediate precipitation step(s) will be carried out at a pH greater than the first pH and less than the second pH.

In these embodiments, the method may comprise selectively precipitating calcite or aragonite in the first precipitation step at a pH of ≤7.5;
then selectively precipitating monohydrocalcite in the intermediate precipitation step at a pH of 8≤pH>7.5; and
then selectively precipitating a second product comprising magnesium carbonate and/or its hydrates and/or magnesium hydroxy carbonate and/or its hydrates in the second precipitation step at a pH of >8.5(e.g. pH≥9). The second product is preferably nesquehonite which may be precipitated at a pH of 9.5-10.

The intermediate product(s) may be separated/filtered, washed and dried as described above for the first and second products.

After the precipitation and separation of the products, the calcium and magnesium ion-depleted second supernatant liquid will remain. This will be alkaline and can be at least partially recycled, or looped, by addition to the water source/brine or preferably to the alkaline aqueous solution. This will increase the pH of the water source/brine/alkaline aqueous solution. Similarly, the wash water used to wash the first and second products can be recycled to the water source/brine or the alkaline aqueous solution.

Where the alkali is ammonia, the ammonium chloride-containing second supernatant liquid can be treated to recover the ammonia, which can then be re-used again, as part of a low loss regeneration process, for CO₂ dissolution and subsequent Ca and Mg product precipitation steps. The ammonia recovery can comprise the following reactions:

(NH₄)₂CO₃(aq)+Mg(Ca)Cl₂(aq)→Mg(Ca)CO₃(s)+2NH₃(g)+2HCl(aq) (20)

(NH₄)₂CO₃(aq)+Mg(Ca)Cl₂(aq)+xH₂O(I)→Mg(Ca)CO₃.xH₂O(s)+2NH₃+2HCl aq) (21)

(NH₄)HCO₃(aq)+Mg(Ca)Cl₂(aq)Mg(Ca)CO₃(s)+NH₃(g)+2HCl(aq) (22)

The reactions can be driven by heat where required, e.g. by heat obtained from the waste gas as it passes through a heat exchanger. The second supernatant liquid can be passed through the heat exchanger in thermal contact with the waste gas.

The acid generated during the ammonia recovery step can be removed from the waste and the de-acidified brine re-cycled into the water source/brine to condition its pH if required.

The method may further comprise activation of the second (magnesium) product by heating. For example, where the second (magnesium) product comprises a hydrated salt (e.g. nesquehonite), the activation step may comprise heating the hydrated salt to produce a lower-hydrate phase which can be subsequently re-hydrated to effect hardening such that the activated second (magnesium) compound can be used as a cementious building product.

In a second aspect, the present invention provides a system for mineral sequestration of carbon dioxide, the system comprising:
a carbon dioxide inlet;
an absorbing stage connected to the carbon dioxide inlet for absorbing carbon dioxide in water containing an alkali to form an alkaline aqueous solution containing carbonate anions;
a water source inlet for providing a water source containing magnesium and calcium ions; and
a precipitation stage connected to the water source inlet for mixing the alkaline aqueous solution containing carbonate anions with the water source, selectively precipitating a first product containing calcium cations and carbonate anions in a first precipitation step at a first pH, and selectively precipitating a second product containing magnesium cations and carbonate anions in a second precipitation step at a second, higher pH.

The carbon dioxide inlet may be connected to a waste gas feed providing a waste gas such as an effluent gas from an industrial plant e.g. a power plant, a chemical processing plant, a cement factory or an oil refinery. In other embodiments, the carbon dioxide inlet may be connected to a waste gas feed providing a waste gas derived from activation by heating of the second product or derived from forming the second product into construction materials.

The system may comprise a gas treatment stage comprising a carbon dioxide scrubber to separate the carbon dioxide from the other components of the waste gas for dissolution within the absorbing stage to form the alkaline aqueous solution containing carbonate ions. Any oxygen and nitrogen in the waste gas are typically vented from the system to atmosphere. The gas treatment stage may also include a particulate matter (PM) filter and/or a thermal heat exchanger. The gas treatment stage may further comprise a water recovery unit for recovering water from the waste gas. The recovered water may be used in the washing stage(s) described below. Recovering water from the waste gas helps reduce dilution of the calcium and magnesium cations in the water source and also reduces the demand for fresh water in the washing stage(s).

The absorbing stage is preferably connected to an alkali feed for addition of the alkali to water within the absorbing stage to form an alkaline aqueous solution. The alkali feed may be for providing any one or more of the alkalis described above for the first aspect.

The absorbing stage preferably comprises a first pH meter/controller for monitoring/controlling the pH of the alkaline aqueous solution.

The absorbing stage may be adapted to bubble the carbon dioxide through or spray it onto the alkaline aqueous solution. The absorbing stage may be adapted to spray the alkaline aqueous solution into/across the flow path of a stream of the carbon dioxide.

The absorbing stage may be adapted to dissolve the carbon dioxide at a temperature of between 0-30° C.

The absorbing stage may be integral with the precipitation stage or it may be separate. Where it is separate, the system further comprises an alkaline aqueous solution feed between the absorbing stage and the precipitation stage for passing the alkaline aqueous solution containing carbonate ions from the absorbing stage to the precipitation stage.

The water source inlet may be connected to a water source comprising formation/connate brine or produced water brine (obtained as a by-product of gas/oil extraction) or other brine sources. The system may comprise a water source/brine filtration and/or treatment stage for filtration/treatment of the water source/brine prior to mixing with the alkaline aqueous solution containing carbonate ions. For example, the system may comprise a produced water treatment stage which may comprise one or more of a de-oiling stage (e.g. comprising a de-oiling cyclone), a soluble organics removal stage, a solids removal stage (e.g. comprising a wellhead de-sanding cyclone) and/or a dissolved gas removal stage (e.g. comprising a dissolved air flotation unit). The dissolved gases removed by the dissolved gas removal stage may be supplied to the carbon dioxide scrubber to extract carbon dioxide for introduction into the carbon dioxide inlet.

The precipitation stage may comprise a first precipitation stage for selectively precipitating the first (calcium) product in a first precipitation step at the first pH (e.g. ≤8.5.5 e.g. between pH 7-8.5), and a second precipitation stage for selectively precipitating the second (magnesium) product in a second precipitation step at the second pH (e.g. >8.5, e.g. pH≥9, e.g. pH≥9.5 such as pH 9.5-10, e.g. around pH 10.)

In these embodiments, the system comprises a first supernatant liquid feed to allow the passage of calcium ion-depleted first supernatant liquid from the first precipitation stage to the second precipitation stage.

In these embodiments, the water source inlet, alkaline aqueous solution feed, alkali feed and first product separation stage are connected to the first precipitation stage and the alkali feed and second product separation stage are connected to the second precipitation stage.

The first precipitation stage may comprise a first reactor vessel having an agitator and/or a pH meter/controller. The first precipitation stage may be adapted to effect the first precipitation step at ambient temperature in order to precipitate calcite as the first product. The first precipitation stage may be adapted to effect the first precipitation step at a temperature ≥40° C. e.g. 40-85° C. (e.g. 40-60° C.) to precipitate aragonite as the first product. In these embodiments, the first precipitation stage may be adapted to effect the first precipitation step at a first pH between 7-7.5 e.g. around pH 7.5.

In other embodiments, the first precipitation stage may be adapted to effect the first precipitation step at ambient temperature and at a pH of 8≤pH>7.5 in order to precipitate monohydrocalcite as the first product.

The second precipitation stage may comprise a second reactor vessel having an agitator and/or pH meter/controller. The second precipitation stage may be adapted to effect the second precipitation step at a temperature of ≤40° C., preferably ≤25° C. in order to precipitate nesquehonite as the second product.

In alternative embodiments, the first and second precipitation stages may be integral. For example, they (and optionally the absorbing stage) may extend within a single plug flow reactor.

The alkali feed may be connected to the precipitation stage for addition of alkali to adjust the pH to the first and/or second pH.

The alkali feed may be connected to a supply of gaseous or aqueous ammonia.

The system may further comprise a product separation stage for separation (e.g. filtering) the precipitated first (calcium) product and second (magnesium) product from the first and second supernatant liquids respectively. The product separation/filtering stage may comprise a first product separation/filtering stage for separating/filtering the precipitated first (calcium) product from the first supernatant liquid and a second product separation/filtering stage for separating/filtering the precipitated second (magnesium) product from the second supernatant liquid.

The or each product separation stage may comprise a respective hydrocyclone separator to separate the precipitated product(s) from the first/second supernatant liquids. The or each product separation stage may comprise a filtering membrane for filtration of the precipitated product(s) from the first/second supernatant liquids.

The system may further comprise a washing stage for washing the precipitated first (calcium) product and second (magnesium) product (to remove chloride salts and residual alkali) after their separation/filtration from the first and second supernatant liquids respectively. The washing stage may comprise a first washing stage for washing the precipitated first (calcium) product after its separation/filtration from the first supernatant liquid and a second washing stage for washing the precipitated magnesium carbonate-containing product after its separation/filtration from the second supernatant liquid.

The system may further comprise a drying stage for drying the precipitated (and washed) first (calcium) product and second (magnesium) product. The drying stage may comprise a first drying stage for drying the precipitated first (calcium) product and a second drying stage for drying the precipitated second (magnesium) product. Each drying stage may include a vacuum unit for drying the/each product under vacuum. The drying stage may include one or more steam drums for effecting de-glomeration of the product(s) and/or further drying of the product(s). Water recovered during the drying stage may be recycled for use in the washing stage(s).

In some embodiments, the system further comprises at least one intermediate precipitation stage for precipitating at least one intermediate product comprising calcium and/or magnesium cations and carbonate anions. In some embodiments, the intermediate product is monohydrocalcite. The intermediate precipitation stage(s) is/are adapted to effect precipitation of the intermediate product(s) at a pH greater than the first pH and less than the second pH.

In these embodiments, the system may comprise: a first precipitation stage for selectively precipitating calcite or aragonite at a pH of ≤7.5; an intermediate precipitation stage for selectively precipitating monohydrocalcite at a pH of 8≤pH>7.5; and a second precipitation stage for selectively precipitating a second product comprising magnesium carbonate and/or its hydrates and/or magnesium hydroxy carbonate and/or its hydrates at a pH of >8.5 (e.g. pH≥9). The second product is preferably nesquehonite and the second precipitation stage may be adapted to effect precipitation of NQ at a pH of 9.5-10.

The system may comprise at least one intermediate product separation/filtering stage, at least one intermediate washing stage and at least one intermediate drying stage for separating/filtering, washing and drying the at least one intermediate product as described above for the first and second products.

The system may further comprise an alkali recycling stage for recycling the calcium and magnesium ion-depleted second supernatant liquid which will be alkaline. The alkaline recycling stage may recycle the second supernatant liquid back to the first precipitation stage or to the absorbing stage.

Where the alkali feed is connected to an ammonia supply, the alkali recycling stage can be used to recover ammonia from the ammonium chloride-containing second supernatant liquid. The recovered ammonia can be directed to the alkali feed and re-used in the absorbing stage. The ammonia recovery can comprise the following reactions:

(NH₄)₂CO₃(aq)+MgCl₂(aq)→MgCO₃(s)+2NH₃(g)+2HCl(aq) (20)

(NH₄)₂CO₃(aq)+MgCl₂(aq)+xH₂O(I)→MgCO₃.xH₂O(s)+2NH₃+2HCl(aq) (21)

(NH₄)HCO₃(aq)+MgCl₂(aq)MgCO₃(s)+NH₃(g)+2HCl(aq) (22)

The reactions can be driven by heat e.g. by heat obtained from the waste gas. Therefore, the system may further comprise a heat exchanger for transferring heat from the waste gas to the alkali recovery stage i.e. to the second supernatant liquid in the alkali recovery phase.

The system may further comprise an activation stage for activation of the second (magnesium) product by heating.

In a third aspect, the present invention comprises an oil or gas field comprising a system according to the second aspect wherein the water source is provided by a produced water separation and treatment plant connected to an oil/gas well.

In some embodiments, the waste gas feed is connected to a power generating plant, a cement factory, a steel factory, or an oil refinery.

### BRIEF DESCRIPTION OF THE DRAWINGS

Embodiments of the invention will now be described by way of example with reference to the accompanying drawings in which:

FIG. 1 is a graph showing selective precipitation of calcium carbonate and nesquehonite at increasing pH;

FIG. 2 is a schematic diagram showing a first embodiment of the present invention;

FIG. 3 is a schematic diagram showing a second embodiment of the system of the present invention; and

FIG. 4 shows a schematic diagram showing a third embodiment of the present invention.

### DETAILED DESCRIPTION AND FURTHER OPTIONAL FEATURES OF THE INVENTION

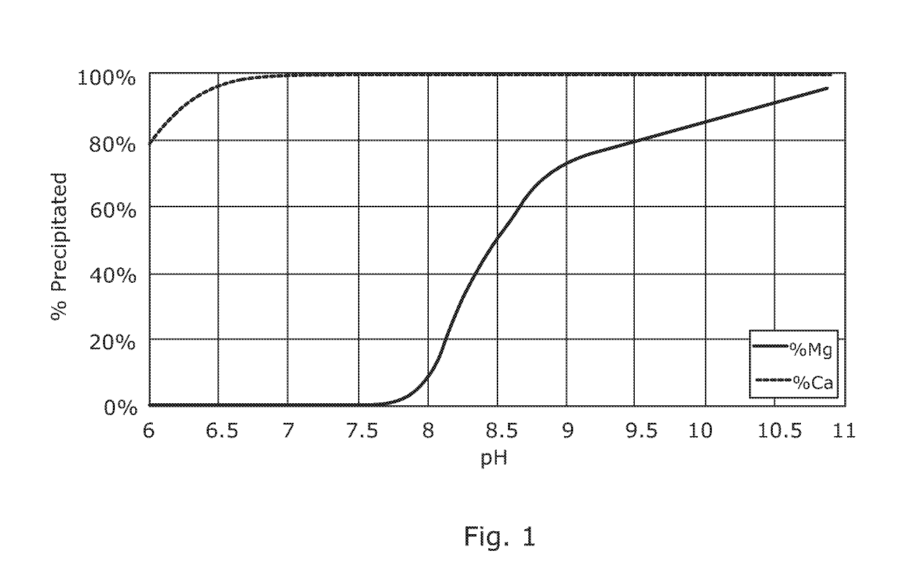

FIG. 1 shows the theoretical yield of the precipitated first (calcium) product (PCC) and the precipitated second (magnesium) product (nesquehonite) at a temperature of 25° C. using a brine having a Ca²⁺Mg²⁺ ratio of 60,000:9,000 ppm and a NaCl concentration of 1.2 mol/L.

In a first precipitation step at a pH of <7.5, precipitation of substantially 100% of the PCC occurs with negligible precipitation of the nesquehonite. Accordingly, the PCC can be separated from the first (calcium ion-depleted) supernatant liquid.

In a second precipitation step carried out on the first supernatant liquid at a pH of >9.5, precipitation of ˜80% of the nesquehonite occurs. Any calcium salts have been previously precipitated in the first precipitation step resulting in the precipitation of substantially pure nesquehonite in the second step. The nesquehonite can be separated from the second supernatant liquid.

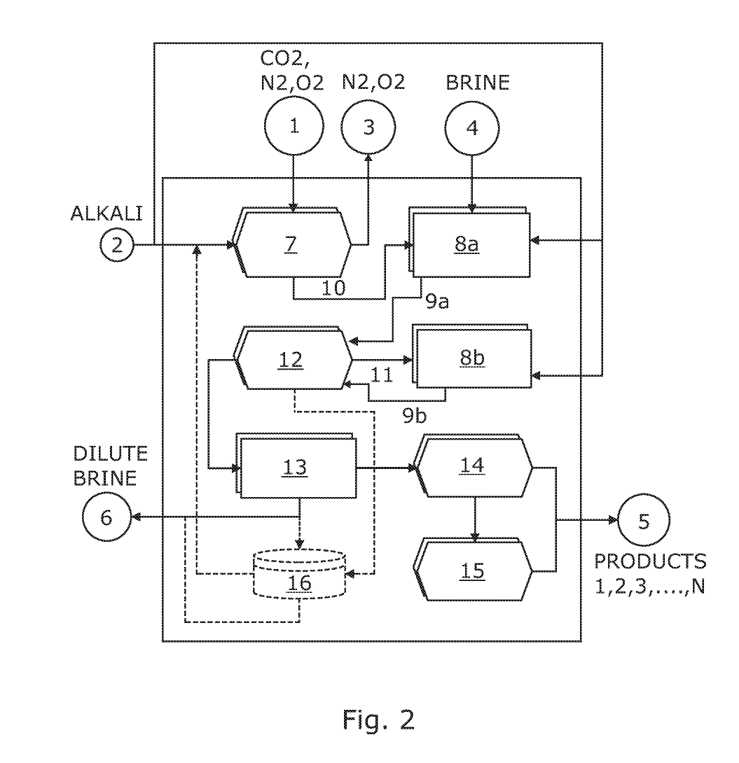

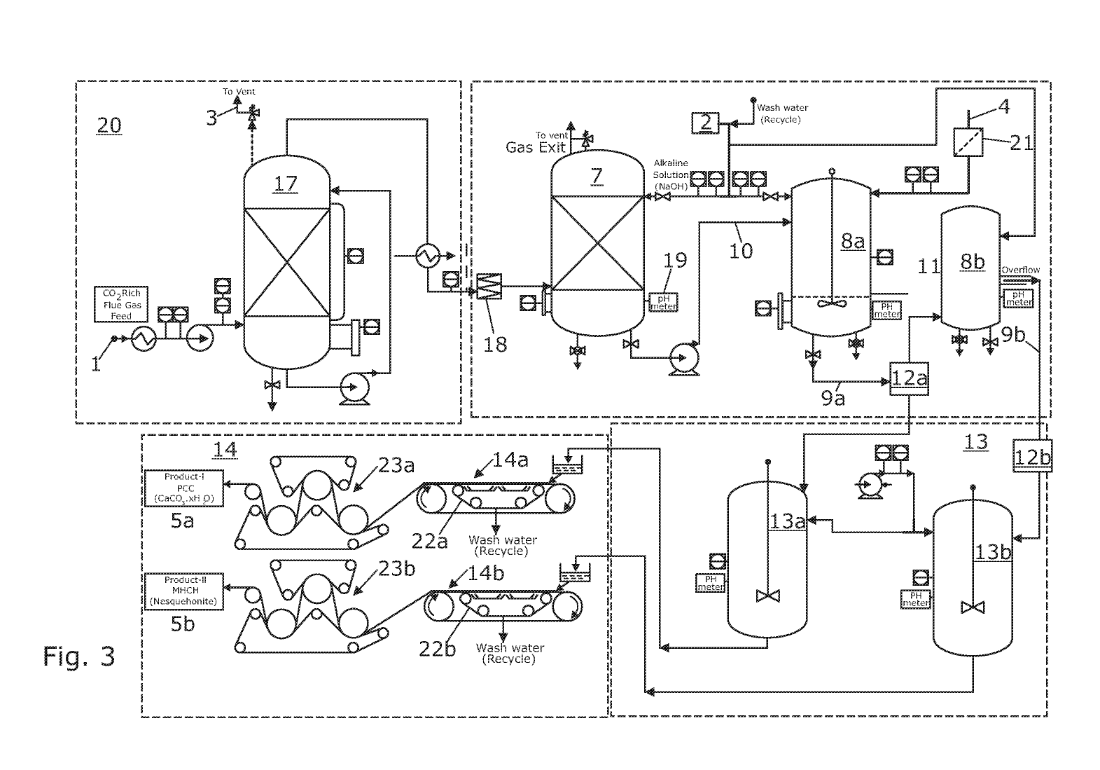

FIGS. 2 and 3 shows a schematic representation of systems according to a first and second embodiment of the present invention.

The systems comprise a carbon dioxide inlet 1 which may be connected to a waste gas feed providing a waste gas such as an effluent gas from an industrial plant e.g. a cement factory.

The carbon dioxide inlet 1 may feed the effluent gas to a gas treatment stage 20 (shown in FIG. 3) comprising a carbon dioxide scrubber 17 and a particulate matter filter 18 to separate the carbon dioxide from the waste gas and to remove any particulates. Any oxygen and/or nitrogen from the waste gas feed are expelled from the systems via a gas outlet 3. A water recovering unit (not shown) may also be included in the gas treatment stage 20 for recovering water vapour from the waste gas. The recovered water may be used in the washing stage 13 described below.

The systems further comprise an alkali feed 2 connected to a source of gaseous or aqueous ammonia.

The systems further comprise an absorbing stage 7 connected to the carbon dioxide inlet 1 and the alkali feed 2. In the absorbing stage 7, ammonia from the alkali feed 2 is dissolved in water to provide an alkaline aqueous solution. Ammonia dissociates into ammonium ions (NH₄⁺) and hydroxide anions (OH⁻) upon dissolution in water.

The alkaline aqueous solution is then sprayed across a stream of the carbon dioxide at a temperature between 0-30° C. in order to dissolve the carbon dioxide to form an alkaline aqueous solution containing carbonate anions.

The carbon dioxide reacts with the hydroxide anions in the alkaline aqueous solution to form the alkaline aqueous solution containing carbonate (and bicarbonate) ions:

CO₂(g)+2NH₃(aq)+H2O(I)→(NH₄)₂CO₃(aq) (5)

CO₂(g)+NH₃(aq)+H₂O(I)→(NH₄)HCO₃(aq) (6)

CO₂(g)+(NH₄)₂CO₃+H₂O(I)→2NH₄HCO₃(aq) (7)

The absorbing stage 7 comprises a pH meter/controller 19 (shown in FIG. 3) for monitoring/controlling the pH of the alkaline aqueous solution and the alkaline aqueous solution containing carbonate anions.

The systems further comprise a water source (brine) inlet 4 for providing a brine containing magnesium and calcium ions. The water source (brine) inlet 4 is connected to a water source comprising formation/connate brine or produced water brine (obtained as a by-product of gas/oil extraction).

The brine contains a higher concentration of calcium ions than magnesium ions. The ratio of calcium ions to magnesium ions in the brine may be around 7:1.

The brine contains calcium ions (e.g. as calcium chloride) in a concentration range of between 2.5 to 100 g/L and magnesium ions (e.g. as magnesium chloride) in a concentration range of 2.5 to 50 g/L e.g. around 9 g/L.

The systems comprise a brine filtration and treatment stage 21 (shown in FIG. 3) for filtration/treatment of the brine. The filtration and treatment stage comprises: a de-oiling stage comprising a de-oiling cyclone; a soluble organics removal stage; a solids removal stage comprising a wellhead de-sanding cyclone; and a dissolved gas removal stage comprising a dissolved air flotation unit. The dissolved gases removed by the dissolved gas removal stage may be supplied to the carbon dioxide scrubber to extract carbon dioxide for introduction into the carbon dioxide inlet 1.

The systems further comprise a precipitation stage 8 which is connected to the water source inlet 4 and is also connected to an alkaline aqueous solution feed 10 extending between the absorbing stage 7 and the precipitation stage 8 for transferring the alkaline aqueous solution containing carbonate ions from the absorbing stage 7 to the precipitation stage 8 where it is mixed with the brine at a temperature of around 5° C. and ambient pressure.

The pH of the mixture is adjusted to a pH of around 7.5 using alkali from the alkali feed 2 and PCC (calcite) is precipitated at a temperature between 0-30° C. and ambient pressure in a first precipitation stage 8a according to the following reactions:

(NH₄)₂CO₃(aq)+CaCl₂(aq)→CaCO₃(s)+2NH₄Cl(aq) (12)

(NH₄)₂CO₃(aq)+CaCl₂(aq)+xH₂O(I)→CaCO₃.xH₂O(s)+2NH₄Cl aq) (13)

If aragonite precipitation is required, the temperature can be increased to ≥40° C. e.g. up to 85° C. or up to 60° C. The systems comprise a first product outlet line 9a connected between the first precipitation stage 8a and a first product separation/filtering stage 12a.

A supernatant liquid feed 11 is provided to allow the passage of calcium ion-depleted first supernatant liquid from the first precipitation stage 8a to the second precipitation stage 8b.

The pH of the first supernatant liquid is adjusted to a second, higher pH of around 9 in the second precipitation stage 8b (by the addition of alkali from the alkali feed 2) and nesquehonite is precipitated at 25° C. and ambient pressure in a second precipitation step according to the following reaction:

(NH₄)₂CO₃(aq)+MgCl₂(aq)+3H₂O(I)→MgCO₃.3H₂O(s)+2NH₄Cl(aq) (19a)

The systems comprise a second product outlet line 9b connected between the second precipitation stage 8b and a second product separation/filtering stage 12b.

The first and second product separation/filtering stages 12a, 12b are for separating/filtering the PCC and nesquehonite from the first and second supernatant liquids respectively.

The product separation/filtering stages 12a /12b each comprise a respective hydrocyclone separator (not shown) and a respective membrane filter (not shown) to separate the precipitated product(s) from the first/second supernatant liquids.

The systems further comprise a washing stage 13 for washing the PCC and nesquehonite (to remove chloride salts and alkali) after their separation/filtration from the first and second supernatant liquids respectively. The washing stage comprises a first washing stage 13a for washing the PCC after its separation/filtration from the first supernatant liquid and a second washing stage 13b for washing the nesquehonite after its separation/filtration from the second supernatant liquid.

Dilute brine resulting from the washing stage 13 is drained from the system at a brine outlet 6. The dilute brine can be safely re-injected into the ground.

The systems further comprise a drying stage 14 for drying the precipitated (and washed) PCC and nesquehonite. The drying stage comprises a first drying stage 14a for drying the PCC and a second drying stage 14b for drying the nesquehonite. Each drying stage includes a vacuum unit 22a, 22b and at least one steam drum 23a, 23b for drying the products.

The washed and dried products may be removed from the systems at product ports 5a, 5b.

The systems may further comprise an activation stage 15 for activation of the nesquehonite by heating.

The systems further comprise an alkali recycling stage 16 for recovering ammonia from the ammonium chloride-containing second supernatant liquid. The recovered ammonia can be directed to the alkali feed 2 and re-used in the absorbing stage 7. The ammonia recovery can comprise the following reactions:

(NH₄)₂CO₃(aq)+MgCl₂(aq)→MgCO₃(s)+2NH₃(g)°2HCl(aq) (20)

(NH₄)₂CO₃(aq)+MgCl₂(aq)+xH₂O(I)→MgCO₃.xH₂O(s)+2NH₃+2HCl aq) (21)

(NH₄)HCO₃(aq)+MgCl₂(aq)MgCO₃(s)+NH₃(g)+2HCl(aq) (22)

These reactions can be driven by heat e.g. by heat obtained from the waste gas. Therefore, the system further comprises a heat exchanger (not shown) for transferring heat from the waste gas to the alkali recovery stage 16.

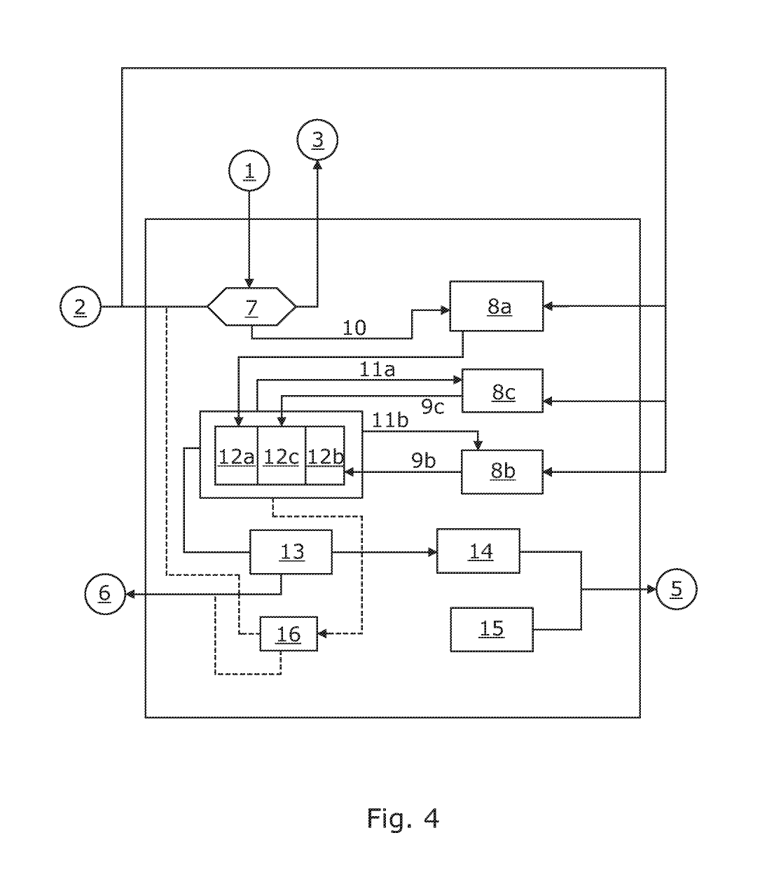

The third embodiment shown in FIG. 4 is essentially the same as the first embodiment described above but an intermediate precipitation stage 8c is included to precipitate an intermediate product.

As discussed above, PCC (calcite) is precipitated in a first precipitation step within the first precipitation stage 8a at a pH of around 7.5.

The system comprises a first product outlet line 9a connected between the first precipitation stage 8a and the first product separation/filtering stage 12a.

A first supernatant liquid feed 11a is provided to allow the passage of first supernatant liquid from the first precipitation stage 8a to the intermediate precipitation stage 8c.

The pH of the first supernatant liquid is adjusted to the intermediate pH of around 8.5 in the intermediate precipitation stage 8c (by the addition of alkali from the alkali feed 2) and monohydrocalcite is precipitated at 0-30° C. and ambient pressure in an intermediate precipitation step.

The system comprises an intermediate product outlet line 9c connected between the intermediate precipitation stage 8c and an intermediate product separation/filtering stage 12c.

An intermediate supernatant liquid feed 11b is provided to allow the passage of intermediate supernatant liquid from the intermediate precipitation stage 8c to the second precipitation stage 8b.

The pH of the intermediate supernatant liquid is adjusted to the second pH of around 9 in the second precipitation stage 8b (by the addition of alkali from the alkali feed 2) and nesquehonite is precipitated at 25° C. and ambient pressure in a second precipitation step according to the following reaction:

(NH₄)₂CO₃(aq)+MgCl₂(aq)+3H₂O(I)→MgCO₃.3H₂O(s)+2NH₄Cl(aq) (19a)

The system comprises a second product outlet line 9b connected between the second precipitation stage 8b and the second product separation/filtering stage 12b.

The product separation/filtering stages 12a, 12b, 12c are for separating/filtering the PCC, monohydrocalcite and nesquehonite from the first, intermediate and second supernatant liquids respectively.

The product separation/filtering stages 12a /12b /12c each comprise a respective hydrocyclone separator (not shown) and a respective membrane filter (not shown) to separate the precipitated product(s) from the first/second supernatant liquids.

The system further comprises a washing stage 13 for washing the PCC and nesquehonite (to remove chloride salts and alkali) after their separation/filtration from the first and second supernatant liquids respectively. The washing stage comprises a first washing stage 13a for washing the PCC after its separation/filtration from the first supernatant liquid, an intermediate washing stage 13c for washing the monohydrocalcite after its separation/filtration from the intermediate supernatant liquid and a second washing stage 13b for washing the nesquehonite after its separation/filtration from the second supernatant liquid.

Dilute brine resulting from the washing stage 13 is drained from the system at a brine outlet 6. The dilute brine can be safely re-injected into the ground.

The systems further comprises a drying stage 14 for drying the precipitated (and washed) PCC, monohydrocalcite and nesquehonite. The drying stage comprises a first drying stage 14a for drying the PCC, an intermediate drying stage for drying the monohydrocalcite and a second drying stage 14b for drying the nesquehonite. Each drying stage includes a vacuum unit 22a, 22b and at least one steam drum 23a, 23b for drying the products.

The washed and dried products may be removed from the system at product ports 5.

The system may further comprise an activation stage 15 for activation of the nesquehonite by heating.

The system further comprises an alkali recycling stage 16 as described above.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

1. A method of mineralisation of carbon dioxide, the method comprising:
forming an alkaline aqueous solution containing carbonate anions by dissolving the carbon dioxide and an alkali in water;
mixing the alkaline aqueous solution with a water source containing magnesium and calcium cations;
selectively precipitating a first product containing calcium cations and carbonate anions in a first precipitation step at a first pH; and
then selectively precipitating a second product containing magnesium cations and carbonate anions in a second precipitation step at a second pH, wherein the second pH is higher than the first pH.

2. A method according to claim 1 wherein the water source is a formation/connate brine, a produced water brine or another industrial waste brine.

3. A method according to claim 1 wherein the water source/brine contains a higher concentration of calcium ions than magnesium ions.

4. A method according to claim 1 wherein the carbon dioxide is derived from an effluent gas from an industrial plant.

5. A method according to claim 1 wherein the alkali for forming the alkaline aqueous solution is selected from sodium hydroxide, potassium hydroxide, calcium hydroxide, Clinker Kiln Dust (CKD), Lime Sludge (LS) or ammonia.

6. A method according to claim 1 wherein the first precipitation step is carried out at a first pH of 8.5.

7. A method according to claim 1 wherein the first product comprises precipitated calcium carbonate (PCC).

8. A method according to claim 7 wherein the first product is selected from calcite, aragonite or calcium carbonate monohydrate.

9. A method according to claim 8 wherein the first product is aragonite and the first precipitation step is carried out at a temperature greater than or equal to 40° C. and a pH of between 7 and 7.5.

10. A method according to claim 8 wherein the first product is calcite and the first precipitation step is carried out at ambient temperature and a pH of between 7 and 7.5.

11. A method according to claim 8 wherein the first product is monohydrocalcite and the first precipitation step is carried out at ambient temperature and at a pH of 8≤pH>7.5.

12. A method according to claim 1 wherein the second precipitation step is carried out at a second pH of >8.5.

13. A method according to claim 1 where the second product is nesquehonite.

14. A method according to claim 13 wherein the second precipitation step is carried out at a temperature equal to or less than 25° C.

15. A method according to claim 1 further comprising at least one intermediate precipitation step for precipitating at least one intermediate product comprising calcium and/or magnesium cations and carbonate anions at a pH between the first pH and the second pH.

16. A method according to claim 15 wherein the first product is aragonite or calcite, the second product is nesquehonite and the intermediate product is monohydrocalcite.

17. A method according to claim 1 wherein the alkali is ammonia and wherein the method further comprises an ammonia recovery step for recovering ammonia from a second supernatant liquid remaining after the second precipitation step.

18. A method according to claim 1 further comprising activation of the second product by heating.

19. A system for mineral sequestration of carbon dioxide, the system comprising:
a carbon dioxide inlet;
an absorbing stage connected to the carbon dioxide inlet for absorbing carbon dioxide in water containing an alkali to form an alkaline aqueous solution containing carbonate anions;
a water source inlet for providing a water source containing magnesium and calcium ions; and
a precipitation stage connected to the water source inlet for mixing the alkaline aqueous solution containing carbonate anions with the water source, selectively precipitating a first product containing calcium cations and carbonate anions in a first precipitation step at a first pH, and selectively precipitating a second product containing magnesium cations and carbonate anions in a second precipitation step at a second, higher pH.

20. A system according to claim 19 wherein the carbon dioxide inlet is connected to a waste gas feed providing an effluent gas from an industrial plant.

21. A system according to claim 19 further comprising a gas treatment stage comprising a carbon dioxide scrubber and/or a particulate matter (PM) filter and/or a thermal heat exchanger.

22. A system according to claim 19 wherein the absorbing stage is adapted to bubble the carbon dioxide through the alkaline aqueous solution or to spray the alkaline aqueous solution into/across a flow path of the carbon dioxide.

23. A system according to claim 19 any nc wherein the water source inlet is connected to a water source comprising formation/connate brine or produced water brine.

24. A system according to claim 23 further comprising a produced water treatment stage comprising one or more of a deoiling stage, a soluble organics removal stage, a solids removal stage and/or a dissolved gas removal stage.

25. A system according to claim 19 wherein the precipitation stage comprises a first precipitation stage for selectively precipitating the first product in a first precipitation step at a first pH of 8.5.

26. A system according to claim 25 wherein the first precipitation stage is adapted to selectively precipitate the first product at a temperature between ambient temperature and 85° C.

27. A system according to claim 19 wherein the precipitation stage comprises a second precipitation stage for selectively precipitating the second (magnesium) product in a second precipitation step at a second pH of ≥9.

28. A system according to claim 27 wherein the second precipitation stage is adapted to selectively precipitate the second product at a temperature less than or equal to 40° C.

29. A system according to claim 19 wherein the alkali feed is connected to a supply of gaseous or aqueous ammonia.

30. A system according to claim 19 further comprising at least one intermediate precipitation stage for the precipitation of at least one intermediate product comprising calcium and/or magnesium cations and carbonate anions.

31. A system according to claim 19 further comprising an alkali recycling stage for recycling a calcium and magnesium ion-depleted second supernatant liquid to the precipitation stage or to the absorbing stage.

32. A system according to claim 31 wherein the alkali recycling stage is adapted to recover ammonia from the second supernatant liquid.

33. A system according to claim 19 further comprising an activation stage for activation of the second product by heating.

34. An oil/gas field comprising a system according to claim 19 wherein the water source is provided from a produced water separation and treatment plant connected to an oil/gas well.

35. An oil/gas field according to claim 34 wherein the waste gas feed is connected to a power generating plant, a cement factory, a steel factory, or an oil refinery.

36. (canceled)

37. (canceled)

38. (canceled)
